(19) United States
(12) Patent Application Publication
(10) Pub. No.: US 2016/0017165 A1
(43) Pub. Date: Jan. 21, 2016

(54) SURFACE COATING BASED ON CROSSLINKABLE FLUOROPOLYMERS

(71) Applicants: Uwe NUMRICH, Groß-Zimmern (DE); André HENNIG, Ingelheim (DE); Markus HALLACK, Schermbeck (DE); Rüdiger JELITTTE, (US); EVONIK RÖHM GMBH, Darmstadt (DE)

(72) Inventors: Uwe NUMRICH, Gross-Zimmern (DE); Andre HENNIG, Ingelheim (DE); Stefan BERNHARDT, Offenbach (DE); Markus HALLACK, Schermbeck (DE); Ruediger JELITTE, Alsbach-Haehnlein (DE)

(73) Assignee: Evonik Roehm GmbH, Darmstadt (DE)

(21) Appl. No.: 14/772,019

(22) PCT Filed: Feb. 14, 2014
(86) PCT No.: PCT/EP2014/052867

§ 371 Date: Sep. 1, 2015

(30) Foreign Application Priority Data
Mar. 13, 2013 (DE) 10 2013 204 395.3

(51) Int. Cl. C09D 127/14; C09D 133/12; C09D 129/10; C09D 5/00; C09D 7/12

(52) U.S. Cl. CPC C09D 127/14; C09D 5/00; C09D 7/1241; C09D 129/10; C09D 133/12

(57) ABSTRACT

The present invention relates to a technology for the treatment of materials for exposed outdoor use with a high-grade, abrasion-resistant surface coating based on a formulation comprising crosslinkable fluoropolymers. The invention further relates to particular embodiments for the surface coating.

### FIELD OF THE INVENTION

The present invention relates to a technology for the treatment of materials for exposed outdoor use with a high-grade, abrasion-resistant surface coating based on a formulation comprising crosslinkable fluoropolymers. The invention further relates to particular embodiments for the surface coating.

Abrasive exposure is unavoidable with materials in outdoor use. Such abrasion is caused in particular by cleaning operations or by wind-borne media, such as sand or dust. As a result, unprotected or inadequately surface-coated materials lose their value or long-term adhesion. The abrasion resistance of thermoplastic polymeric materials is low, and they are consequently unsuitable or of only extremely limited suitability for the surface coating of materials in exposed outdoor use.

Materials in outdoor use are additionally subject to pronounced adverse exposure from the UV component of solar radiation. A high-grade surface coating must therefore likewise ensure pronounced protection of the substrate with respect to UV radiation, without itself being subject to potential for inherent damage caused by UV radiation.

Flexible thin-film solar modules and flexible OLED and display materials, for example, are additionally subject in outdoor use to a distinct potential for corrosion of key functional layers. In these application segments, therefore, a high-performance surface coating must likewise provide appropriate protection from corrosion and also barrier properties with respect to moisture migration.

### PRIOR ART

Examples of known materials for coatings in outdoor use are polysiloxanes, such as Crystalcoat™ MP-100 from SDC Techologies Inc., AS 400-SHP 401, or UVHC3000K, both from Momentive Performance Materials. In long-term application over a period of at least 20 years in an outdoor region, as required in particular for solar reflectors or photovoltaic cells, however, such materials do not display adequate abrasion resistance.

In U.S. Pat. No. 5,118,540 the surface protection is improved by adhesively bonded application of abrasion-resistant and moisture-resistant sheeting based on fluorocarbon polymers, such as PVDF. Not only the UV absorption reagent but also the corrosion inhibitor are components of the adhesive layer by which the sheeting is joined to the metal surface of the vapour-coated polyester carrier film. The adhesive layer here can again consist, in analogy to the dual (meth)acrylate coating set out above, of two different layers, in order to separate corrosion inhibitor from UV absorption reagent. Such a coating, however, does not exhibit sufficient long-term resistance towards scratching.

A further solution in the prior art are inorganic scratch-resistant coatings. EP 1 629 053 discloses a coating of this kind composed of silicon dioxide particles or aluminium oxide particles with diameters of less than 1 μm for the coating of film laminates which find use as weather-resistant sheets. A disadvantage of such inorganic coatings, however, is that they are durable only for a relatively short time, in other words not more than a few years, under weathering conditions. Drifting sand, and certainly sandstorms, or other climatic conditions in very hot and especially dry environments result in abrasion of such coatings.

EP 2 524 802 discloses coatings for the weathering protection of solar installations, comprising isocyanate-crosslinked, hydroxy-functional fluoropolymers. These coatings already have very good abrasion resistance and weathering stability. A problem, however, is the limited usefulness, since the adhesion of these coatings to many substrates is limited. A similar system for the same application is found in WO 2011/105515.

WO 98/44015 discloses compositions comprising polyisocyanates, hydroxy-functional fluoropolymers and hydroxy-functional unfluorinated polyols, which as well as low molecular weight diols are also polyester, polyether or polycarbonate polyols. Especially in terms of their weathering resistance, however, such compositions are capable of improvement.

EP 2 298 842 discloses coatings, for car production, for example, that consist of polyether-based polyisocyanate prepolymers and of polyols that do not contain fluorine. Such a composition has very good weathering properties and a sufficient abrasion resistance for car production. For other applications under mechanical exposure in the outdoor sector, however, the abrasion resistance is inadequate.

### Problem

The problem was that of providing an innovative surface enhancement for plastics or metal surfaces. The intention with this surface enhancement in the context of outdoor applications was to ensure a simultaneous combination of particularly good abrasion resistance, scratch resistance, weathering resistance and substrate protection properties.

A further intention was that this surface enhancement could be made transparent and/or colourless. Moreover, this surface enhancement is intended to offer good chemical resistance, barrier properties, with respect to water vapour or oxygen, for example, and dirt repellency properties.

A further problem was that the surface enhancement in respect both of the substrates to be coated and of the coating technology to be employed should be capable of broad application.

A further problem was that of providing a surface enhancement for outdoor applications that is easy and cost-effective to produce and apply.

Further problems not explicitly stated may emerge from the description, claims or else examples in this specification.

### Solution

Against the background of the prior art and the deficient technical solutions described therein for long-term applications, success is achieved in the present invention in providing, in a way not readily apparent to the skilled person, a coating having a surface quality which is improved over a long time period. This success is achieved with an innovative composition for the coating of substrates that comprises 5 to 70 wt %, preferably 10 to 55 wt % of a hydroxy-functional fluoropolymer, 5 to 70 wt %, preferably 10 to 55 wt % of a (meth)acrylate polyol, 5 to 35 wt %, preferably 10 to 30 wt % of a polyisocyanate, 0.001 to 0.2 wt %, preferably up to 1 wt % of a crosslinking catalyst, 0.5 to 20 wt % of preferably triazine-based UV absorbers and 0.5 to 10 wt % of preferably HALS-based UV stabilizer and 5 to 80 wt %, preferably up to 40 wt % of a solvent. The fluoropolymers and the (meth)acrylate polyols here account in total for 20 to 75 wt % of the composition. Moreover, the fluoropolymers and the (meth)acrylate polyols together have an OH number of between 50 and 400 mg KOH/g, preferably between 90 and 250 mg KOH/g.

With particular preference the hydroxy-functional fluoropolymer is a copolymer of tetrafluoroethylene (TFE) and/or chlorotrifluoroethylene (CTFE) on the one hand and of vinyl esters, vinyl ethers and/or alpha-olefins on the other hand. With particular preference it is an alternating copolymer of CTFE or TFE on the one hand and of the other comonomers on the other hand. In such polymers the hydroxyl functionality is obtained by copolymerization of hydroxy-functional vinyl ethers and/or alpha-olefins.

Examples of commercially available hydroxy-functional fluoropolymers are sold by Asahi Glass under the product name Lumiflon®, by Solvay Solexis under the name FluoroLin® or by Daikin under the product name Zeffle®.

Since the fluoropolymers used and also poly(meth)acrylates are completely amorphous, the corresponding formulations and coatings have good optical properties and high transparency. Furthermore, both fluoropolymers and poly(meth)acrylates possess very good weathering resistance over a very long time span, even under extreme conditions. The coatings of the invention, accordingly, are extremely UV-stable and, moreover, have very good barrier properties with respect to atmospheric oxygen and water, in the form of atmospheric humidity, for example.

To establish the required weathering stability and also substrate protection properties of the coating, a further necessity is the addition of 0.5 to 20 wt %, preferably up to 15 wt %, of preferably triazine-based UV absorbers and/or 0.5 to 10 wt %, preferably up to 7.5 wt %, of preferably HALS-based UV stabilizers.

The composition may further comprise 5 to 40 wt % of a hydroxy-functional silicone resin as well. This silicone resin has an OH number of between 50 and 300 mg KOH/g, preferably between 90 and 200 mg KOH/g. Silicone resins of these kinds also increase the heat resistance of the composition. Moreover, with a relatively high proportion of this component in conjunction with a somewhat lower proportion of the other polymer components, the solids content of the composition overall can be raised. An example of such hydroxy-functional silicone resins is Xiameter® RSN-0255 from Dow Corning.

The poly(meth)acrylates used consist to an extent of at least 60 wt % of methacrylate-based monomer units. The polymers in question in particular are preferably suspension polymers or solution polymers, composed with particular preference of at least 70 wt % of methyl methacrylate (MMA) and/or butyl methacrylate (BuMA). The hydroxy functionalization here can be achieved through copolymerization of suitable monomers, such as hydroxyethyl (meth)acrylate or hydroxypropyl (meth)acrylate, for example, and/or by using hydroxy-functional chain transfer agents, such as mercaptoethanol, for example. The molecular weight is 10 000 to 300 000 g/mol and the glass transition temperature is in the range between 10 and 130° C.

Solvents contemplated include in principle all solvents and solvent mixtures which are suitable for the other components employed in accordance with the invention. These solvents may more particularly be ketones such as acetone or methyl ethyl ketone, esters such as ethyl, propyl or butyl acetate, aromatics such as toluene or xylene, or ethers such as diethyl ether or ethyl ethoxypropionate.

More particularly, however, the solvent may also be water. Surprisingly it has been found that the other constituents of the composition of the invention form a stable dispersion even in water, in particular, and that with water as solvent, a corresponding coating material can be applied easily and eco-friendlily.

The polyisocyanates in the composition are generally isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI) and/or norbornane diisocyanate (NBDI).

Crosslinking catalysts used are normally dibutyltin dilaurate (DBTDL), zinc octoate, bismuth neodecanoate and/or tertiary amines, preferably 1,4-diazabicyclo[2.2.2]-octane. One example of a suitable such crosslinker is Desmodur® BL 3175 from Bayer. Generally speaking, the amount of crosslinker is set such that the ratio between OH groups and NCO groups is between 0.5 to 1.5, preferably between 0.8 and 1.2 and more preferably between 0.9 and 1.1. These exemplary figures pertain in particular to systems comprising HDI condensates and DBTDL. With other systems, whose components deviate more significantly in terms of the respective molecular weights or number of functionalities, the limiting ranges specified can be adapted accordingly.

Furthermore, the composition may additionally comprise up to 20 wt % of a silane-functional alkyl isocyanate or of a glycidyl-functional alkylsilane. These components contribute additionally to the adhesion properties with respect to the substrate to be coated. One preferred silane-functional alkyl isocyanate is trimethoxypropylsilyl isocyanate, which is sold for example by Evonik Industries under the name Vestanat EP-M 95. One preferred example of a glycidyl-functional alkylsilane is 3-glycidyloxypropyltrimethoxysilane, which is available for example from Evonik Industries under the name Dynasylan GLYMO.

Furthermore it is also possible in particular for inorganic nanoparticles to be present, especially comprising silicon oxides, for the purpose of additional enhancement of the scratch resistance and abrasion resistance in the composition. Up to 40 wt %, preferably up to 30 wt %, of these nanoparticles may have been added. It is especially preferred here for these nanoparticles not to have refractive properties and for the polymer matrix not to be made cloudy.

Also part of the present invention, in addition to the composition described, is a substrate coated with a composition of the invention. The coating in that case after drying and crosslinking preferably has a thickness of between 0.5 and 200 μm, preferably between 2 μm and 150 μm and more preferably between 5 μm and 50 μm.

The advantages of the substrates coated in accordance with the invention over the prior art are set out below.

The preferably transparent coatings of the invention are particularly colour-neutral and do not become cloudy under the influence of moisture. The coating, furthermore, exhibits excellent weathering stability and very good chemicals resistance, with respect for example to all commercial cleaning products. These aspects as well contribute to the retention of surface quality over a long time period.

The material of the invention can also be employed in outdoor applications over a very long period of at least 15 years, preferably even at least 20 years, more preferably at least 25 years, at locations with particularly intense solar radiation, such as in the southwest USA or the Sahara, for example.

The coatings of the invention have very good properties especially when the surface is subject to mechanical exposure. This means that the lifetime of the substrates is extended even in regions regularly experiencing sandstorms or winds of high dust content or when the surface is regularly cleaned using brushes.

The coating of the invention, furthermore, is particularly stable towards moisture, especially with regard to rainwater, atmospheric humidity or dew. The coating, therefore, does not display the known susceptibility to delamination of the coating from the substrate under the influence of moisture. Fluorine-based coatings, furthermore, possess a particularly good water barrier effect. Fluorine-based coatings, moreover, exhibit a particularly good oxygen barrier effect and therefore have very good properties in respect of corrosion control.

In addition the coatings of the invention exhibit very good scratch resistance and abrasion resistance, and so this effect contributes additionally to the long life of the substrates.

### Methods

As well as the compositions for coating that have already been described, methods for the coating of substrates are also part of the present invention. In this method for the coating of a substrate, the substrate is coated with a composition of the invention as described above, and the coating is subsequently dried and crosslinked.

Use is made more particularly of a method in which the composition of the invention is applied in organic solution together with further formulating constituents as an “organosol” to the composite moulding, and the applied layer is subsequently dried. Coating here takes place by means for example of knife coating, roll coating, dip coating, curtain coating and/or spray coating. Drying is accompanied by the crosslinking of the coating.

This method step of coating may take place in a coating unit on a prefabricated uncoated composite moulding. Coating may alternatively and preferably be carried out in-line, directly after the production of the substrate, in the form of a composite moulding, for example. The substrates are produced for example, in one embodiment, as a multi-layer sheet by lamination. In such a case the above-described coating unit is set up in-line after the laminating unit, and coating takes place on the freshly produced substrate.

With regard to the end product there are a number of embodiments. In the first embodiment, coating takes place directly onto the substrate.

In a second embodiment, the coating is realized in the form of a surface coating sheet, furnished with the coating formulation of the invention, onto the respective substrate material. In this case the first operation is for the coating formulation of the invention to be coated with firm adhesion onto a corresponding film substrate material. This is then followed by the application of this surface coating sheet to the respective final substrate material. The bottom face of the surface coating sheet here is either coated with a self-adhesive formulation or furnished with a hotmelt or with an adhesive layer. This modification of the bottom face attaches either “thermoplastically” or “reactively” on the final substrate material in the event of temperature- and pressure-assisted application.

In this way, via the physical properties of the surface coating sheet, it is possible to realize additional product features, including those of an optical kind, for example. Moreover, a method of this kind is very flexible, and can be employed, for example, in situ with relatively large substrates to be coated, without manipulation of solvents or high temperatures.

In a third variant, similar to the second embodiment, the coating is realized in the form of a thermal transfer operation of the coating formulation of the invention onto the respective substrate material. Here, in a first coating step, the film or paper carrier material in question is furnished with a release layer, which allows thermal transfer of the inventive coating formulation, applied in a second coating step, to the respective substrate material. Optionally here, if necessary, in a third coating step, an adhesive layer can be applied, ensuring proper adhesion of the thermal transfer layer system to the respective substrate material.

The coating of the invention can subsequently be provided optionally with one or more additional functional layers. The layers in question may comprise, for example, a scratch-resistant coating, a conductive layer, an anti-soiling coating and/or a reflection-increasing layer or other layers with optical functions. These additional layers may be applied for example by means of Physical Vapour Deposition (PVD) or Chemical Vapour Deposition (CVD).

An additional scratch-resistant coating may optionally be applied for further improving the scratch resistance. Generally speaking, however, no such additional layer is necessary, given the good quality of the composite mouldings of the invention. Scratch-resistant coatings may be, for example, silicon oxide layers, which are applied directly by means of PVD or CVD.

Furthermore, in order to facilitate cleaning, the surface of the composite mouldings may be furnished with a dirt-repelling or dirt-destroying coating, referred to as an anti-soiling coating. This coating as well may be applied by means of PVD or CVD.

As a further exemplary option, a further, comparatively thin, extremely abrasion-resistant layer is located on the coating of the invention as well. This additional layer is a particularly hard thermoset layer with a thickness preferably below 5 μm, more preferably between 0.5 and 2.0 μm. This layer may be produced for example from a polysilazane formulation.

### DETAILED DESCRIPTION OF THE USE

The surface coating technology of the invention can be employed in the following application segments:

1. For the coating of thermosets, intended for example for outdoor application as high-pressure laminate panels for architectural facing design.

2. For the coating of decorative laminates, which are used, for example, for the surface design of window profiles, cafe furniture or wall linings.

3. OLEDs (organic light-emitting diodes):

As a coating particularly on flexible OLEDs, it is possible for better durability, a distinct improvement in scratch protection and a long-term usability in outdoor areas to be realized. One particular embodiment of the OLEDs are rollable displays. These are subject in particular to high mechanical stresses, and with a coating of the invention the displays have a longer life.

4. Exterior Window Films:

The treatment of external windows has a large part to play in relation to the heat insulation, especially when outside temperatures are high. A particular weathering stability is of great importance for this. Furthermore, in this application, the high transparency of the coating is a particular factor.

5. Anti-corrosion coatings (Heavy-Duty Coatings):

These multi-ply coating systems are especially important with steel structures, such as in bridge building or else in buildings. Here, using the coating technology of the invention, the top ply (topcoat) of this multi-ply coating is designed, thereby making it possible to obtain significantly prolonged corrosion control with in particular improved long-term adhesion of the coating, relative to the prior art.

A field of use of equal interest is that of systems for solar energy recovery. More particularly:

6. Thin-film solar cells.

Factors particularly relevant here are the high UV resistance of the coating and also the very good weathering stability even under extreme weathering effects, such as sandstorms or high temperatures.

7. Mirrors for concentrating solar radiation, especially in concentrating solar thermal power stations.

With these mirrors as well, the focal point is in particular the corrosion control, the scratch resistance, the transparency and the long-term adhesion of the coating, and the very good weathering stability.

8. Photovoltaic backsheets: reverse-face coating of photovoltaic modules. Very important here in particular are the protection from moisture, UV radiation and other effects of weathering.

### EXAMPLES

Scratch hardness investigation with 1-3 N scoring force

Procedure: Prior to testing, the samples are surface-cleaned. Testing takes place with a ZHT 2092 Zehntner hardness testing scribe with a 0.75 mm test tip, from Bosch, an ACC 112 trolley and various compression springs. Using different defined compression springs, with different forces, the test tip is drawn in a straight line over the sample specimen.

The spring force is adjusted by pre-tensioning of the compression spring, the hardness testing scribe is placed with the tip onto the surface, and the testing instrument is pressed perpendicularly onto the surface against the spring pressure. The trolley is then drawn over the sample specimen in a straight line and with a speed of approximately 10 mm/s, away from the body. This operation should be repeated, with the spring force changed, until a slight injury to the test surface becomes visible. After the test cycles, the compression spring should be released. The position of the slide on a scale shows the force (N) and hence directly the test value that corresponds to the hardness. The lowest force which has made a visible score into the material is used as the result. With the tactile measuring instrument it is possible, optionally, to determine the depth of scoring.

### Preliminary Stage 1

The preliminary stage below represents by way of example a substrate which can be employed as a mirror for concentrating solar radiation.

A composite sheet 0.15 mm thick, consisting of 0.125 mm PMMA Plexiglas 7H, UV-additized with 2% CGX 006 and 0.6% Chimasorb 119, and also of 0.025 mm Makrolon 2607 polycarbonate, is produced by means of adapter coextrusion. This is followed by the application of the reflecting coating by means of a plasma-assisted sputtering operation onto the polycarbonate side of the composite sheet, said coating being composed, in the following order, considered starting from the polycarbonate film, of 0.5 nm ZAO (zinc aluminium oxide), 100 nm Ag and 50 nm Cu.

### Comparative Example

28.9 wt % of Lumiflon LF-9716 are introduced in a solvent mixture of 12.4 wt % ethyl ethoxypropionate and 37.3 wt % butyl acetate and admixed in succession and with stirring with 0.0013 wt % of DBTDL (dibutyltin dilaurate; crosslinking catalyst), 3.4 wt % of Tinuvin 400 (UV absorber) and 1.1 wt % of Tinuvin 123 (HALS compound) until a homogeneous and clear mixture has formed. Then 16.9 wt % of Desmodur N 3300 (polyisocyanate, crosslinker) are incorporated by stirring for 10 minutes. Using a 40 μm wire doctor, the coating material is applied to the PMMA side of the substrate from preliminary stage 1 under standard climatic conditions. Drying and preliminary curing take place in a forced-air oven at 80° C. for 2 hours. The coating is tack-free after just 10 minutes. Subsequent hardening takes place either over 7 days at room temperature or for 2 hours at 80° C.

### Inventive Example

Here, 30 wt % of the Lumiflon LF 9716 are replaced by the methacrylate-based polyol Degalan 4800-L.

The cure rate of this coating of the invention, especially in a roll-to-roll operation, is significantly increased as a result (lower tack-free time), thereby significantly reducing the costs of the coating. There is also a drop in the formulating costs, owing to the partial replacement of the comparatively expensive fluoropolymer polyol by the comparatively favourable methacrylate polyol.

Moreover, a distinctly improved economy of the surface coating in the stated application segments is made possible.

The other coating properties remain unaffected.

According to the scratch hardness measurement conducted, the coating of the inventive example exhibits a significantly lower surface damage than the coating of the comparative example.

1. A composition comprising:
5 to 70 wt % of a hydroxy-functional fluoropolymer;
5 to 70 wt % of a (meth)acrylate polyol;
5 to 35 wt % of a polyisocyanate;
0.001 to 0.2 wt % of a crosslinking catalyst;
5 to 80 wt % of a solvent;
0.5 to 20 wt % of UV absorber; and
0.5 to 10 wt % of UV stabilizer,
the fluoropolymers and the (meth)acrylate polyols accounting in total for 20 to 75 wt % of the composition and together having an OH number of between 50 and 400 mg KOH/g.

2. The composition according to claim 1, wherein the OH number of the fluoropolymers and of the (meth)acrylate polyols together is between 90 and 250 mg KOH/g.

3. The composition according to claim 1, wherein the hydroxy-functional fluoropolymer is a copolymer of tetrafluoroethylene (TFE) and/or chlorotrifluoroethylene (CTFE), or of vinyl esters, vinyl ethers and/or alpha-olefins, the hydroxy-functional fluoropolymer having been obtained with copolymerization of hydroxy-functional vinyl ethers and/or alpha-olefins.

4. The composition according to claim 1, wherein the composition further comprises 5 to 40 wt % of a hydroxy-functional silicone resin, and the silicone resin has an OH number of between 50 and 300 mg KOH/g.

5. The composition according to claim 1, wherein the composition comprises as UV absorber 0.5 to 15 wt % of a triazine and as UV stabilizer 0.5 to 7.5 wt % of a HALS compound.

6. The composition according to claim 1, wherein the (meth)acrylate polyol has a molecular weight of between 10,000 and 300,000 g/mol and a glass transition temperature of between 10 and 130° C.

7. The composition according to claim 1, characterized in that wherein the polyisocyanate is isophorone diisocyanate (IPDI), hexamethylene diisocyanate (HDI), diisocyanatodicyclohexylmethane (H12MDI), 2-methyl-pentane diisocyanate (MPDI), 2,2,4-trimethylhexamethylene diisocyanate/2,4,4-trimethylhexamethylene diisocyanate (TMDI) and/or norbornane diisocyanate (NBDI), and in that the crosslinking catalyst comprises dibutyltin dilaurate, zinc octoate, bismuth neodecanoate and/or tertiary amines, preferably 1,1 diazabicyclo[2.2.2]octane.

8. The composition according to claim 1, wherein the composition further comprises up to 20 wt % of a silane-functional alkyl isocyanate or of a glycidyl-functional alkylsilane.

9. The composition according to claim 1, wherein the solvent is water.

10. A substrate wherein the substrate is coated with a composition according to claim 1 and the coating after drying and crosslinking has a thickness of between 0.5 and 200 μm.

11. A method for coating a substrate, comprising:
coating the substrate with a composition according to claim 1; and then
subsequently drying and crosslinking the coating.

12. The method according to claim 11, wherein the substrate is a surface coating sheet coated on one side with the composition and coated on the other side with a layer having adhesive properties, and wherein the surface coating sheet is optionally adhesively bonded to a second substrate.

13. The method according to claim 11, wherein the substrate is coated by thermal transfer technology with the composition, and the composition is first applied to a film or paper carrier material furnished with a release layer.

14. The method according to claim 11, wherein the coating obtained is coated additionally with a further scratch-resistant coating, conductive layer, anti-soiling coating and/or reflection-enhancing layers or other layers with optical functions.

15. A process comprising employing the composition according to claim 1 for the surface enhancement of decorative laminates, OLEDs, thermosets, rollable displays or exterior window films or as anti-corrosion coatings.

16. A process comprising employing the composition according to claim 1 for the surface enhancement of thin-film solar cells, mirrors for concentrating solar radiation, or photovoltaic backsheets.
